(19) United States
(12) Patent Application Publication
(10) Pub. No.: US 2023/0408450 A1
(43) Pub. Date: Dec. 21, 2023

(54) Membrane resonator array with backside exposure cavity for gas/chemical sensing

(71) Applicant: Georgia Tech Research Corporation, Atlanta, GA (US)

(72) Inventors: Zhenming Liu, Atlanta, GA (US); Farrokh Ayazi, Atlanta, GA (US); Mojtaba Hodjat-Shamami, Atlanta, GA (US); Ardalan Lotfi, Atlanta, GA (US)

(21) Appl. No.: 18/204,184

(22) Filed: May 31, 2023

Related U.S. Application Data
(63) Continuation-in-part of application No. 18/095,261, filed on Jan. 10, 2023, now abandoned.
(60) Provisional application No. 63/298,360, filed on Jan. 11, 2022.

(51) Int. Cl. G01N 29/036; G01N 29/22

(52) U.S. Cl. CPC G01N 29/036; G01N 29/222; G01N 2291/0256; G01N 2291/02408

(57) ABSTRACT

A sensor for sensing a target substance in an analyte includes a sensing device. The sensing device includes: a substrate that defines a cavity therethrough that receives the analyte; a membrane that is affixed to the substrate to isolate the top side of the sensor from the cavity; an actuator that causes the membrane to vibrate; a functionalizing material applied to the bottom side of the membrane and that has a property such that the membrane resonates at a second frequency when it comes in contact with the target substance; and a detector that indicates when the membrane is resonating a frequency characteristic of the presence of the target substance. An electronic circuit generates an output indicative of whether the target substance is present in the analyte based on the signal from the resonant frequency detector and is isolated from the analyte.

### CROSS-REFERENCE TO RELATED APPLICATION(S)

This application is a continuation-in-part of and claims the benefit of U.S. patent application Ser. No. 18/095,261, filed Jan. 10, 2023, the entirety of which is hereby incorporated herein by reference.

This application also claims the benefit of U.S. Provisional Patent Application Ser. No. 63/298,360, filed Jan. 11, 2022, the entirety of which is hereby incorporated herein by reference.

### BACKGROUND OF THE INVENTION

### 1. Field of the Invention

The present invention relates to fluid sensing devices and, more specifically, to a membrane resonator fluid sensing device.

### 2. Description of the Related Art

Conventional gravimetric resonator-type gas/chemical sensors use thin-film bulk acoustic resonators (FBAR) and surface acoustic wave (SAW) resonators operating in the GHz range. Although the use of ultra-high frequency enhances the gravimetric sensitivity, these resonators consume more power due to their high frequency. On the other hand, low-power, lower-frequency (103-105 Hz) designs, such as cantilevers, typically have lower quality factors and limited sensitivity.

A piezoelectric resonator may be suitable for low-power gravimetric gas sensing. Many piezoelectric gravimetric sensors use FBAR and SAW resonators operating in the GHz range. On the other hand, low-power, lower-frequency (10³˜10⁵ Hz) designs, such as a cantilever, usually have lower Q and limited sensitivity.

Although membrane mode resonators have been used in particle/gas/chemical sensing applications, such resonators typically include special electrode covering layers to prevent chemical changes to the electrodes used in the sensing operation. Such layers are necessary when the resonator is exposed to corrosive environments.

Ammonia is one of the most commonly produced industrial chemicals in the world. The concentration and detection range of existing sensors varies from sub-ppm as a biomarker for diseases such as chronic kidney disease to over one percent in leak detection applications.

One type of gas sensor uses a gravimetric resonator that includes a membrane coated with a functional material. Upon exposure to the target gas, the functional material interacts with the target gas molecules and the resonant frequency of the membrane drops due to the mass loading effect.

Among different gas/chemical sensing mechanisms, including chemiresistive and optical sensing, micro-resonator-based gravimetric chemical sensors have several advantages, including: low cost, high sensitivity, and ease of integration with integrated circuits. By selectively depositing a functional material on the membrane, a gravimetric resonator array can be used in gas detection applications. A lateral bulk acoustic wave resonator (LBAR) sensor platform shows high sensitivity to different volatile organic compounds. However, the platform is functionalized on the front side, and metal electrodes are exposed to gases, making it less suitable for detecting ammonia or other corrosive gases sensing. Due to corrosion, ammonia sensors usually require a protective layer for the vulnerable metal electrodes, such as thermally-transduced resonators, in which the electrodes are covered with a silicon dioxide layer.

Body fluids contain various types of diagnostic information. Among them, sweat (i.e., perspiration) is gaining attention due to its non-invasive sampling, ease of sampling preparation, and inert nature. Sweat analysis can be used to diagnose various types of diseases. Cystic fibrosis is a disease caused by the modification of the CFTR gene. Without the CFTR protein, the transport of sodium and chloride is hampered, resulting in formation of mucus in various organs. Clinical symptoms of cystic fibrosis include chronic bacterial infection of the airways and sinuses, fat maldigestion due to pancreatic exocrine insufficiency, infertility in males due to obstructive azoospermia and elevated concentrations of chloride in the patient's perspiration. Thus, cystic fibrosis can be diagnosed based on chloride concentration in perspiration. While healthy adults have a chloride concentration below 30 mmol/L, cystic fibrosis patients typically show values around 60 mmol/L or higher.

Two common types of perspiration analysis sensors include electrochemical sweat sensors and colorimetric sweat sensors. An electrochemical sensor utilizes enzymic reaction to generate current and functions as an amperometric sensor. It can also use ion-selective electrodes to measure heavy metal ions. Colorimetric sweat sensors incorporate chromatic assay arrays, which change color based on the concentration of target chemical.

Therefore, there is a need for a membrane resonator sensor in which the electrodes are not exposed to the fluid being analyzed

### SUMMARY OF THE INVENTION

The disadvantages of the prior art are overcome by the present invention which, in one aspect, is a sensor, having a first side and an opposite second side, for sensing at least one target substance in an analyte that is disposed adjacent to the second side. The sensor includes a first sensing device that includes: a substrate that defines a cavity therethrough, the cavity configured to receive the analyte therein; a membrane, having a top side and an opposite bottom side, the bottom side affixed to the substrate so as to isolate the top side of the membrane and the first side of the sensor from the first cavity; an actuator affixed to the top side of the membrane and configured to cause the membrane to vibrate at a first frequency; a functionalizing material applied to the bottom side of the membrane and exposed to the cavity, the functionalizing material having a property such that when the target substance comes in contact with the functionalizing material, the membrane resonates at a second frequency that is different from the first frequency; and a resonant frequency detector that generates a signal that indicates whether the membrane is resonating at the first frequency or at the second frequency. An electronic circuit is responsive to the signal from the resonant frequency detector and is configured to generate an output indicative of whether the target substance is present in the analyte based on the signal from the resonant frequency detector. The electronic circuit is disposed on the first side of the sensor so as to be isolated from the analyte.

In another aspect, the invention is a fluid sensor, having a first side and an opposite second side, for sensing at least one target substance in an analyte that is disposed adjacent to the second side. The fluid sensor includes a substrate. A plurality of sensing devices is formed on the substrate. Each sensing device includes: a cavity defined through the substrate, the cavity configured to receive the analyte therein; a membrane, having a top side and a bottom side, the bottom side affixed to the substrate so as to isolate the top side of the membrane and the first side of the sensor from the first cavity; an actuator affixed to the top side of the membrane and configured to cause the membrane to vibrate at a first frequency; a functionalizing material applied to the bottom side of the membrane and exposed to the cavity, the functionalizing material having a property such that when the target substance comes in contact with the functionalizing material, the membrane resonates at a second frequency that is different from the first frequency; and a resonant frequency detector that generates a signal that indicates whether the membrane is resonating at the first frequency or at the second frequency. An electronic circuit is responsive to the signal from the resonant frequency detector and is configured to generate an output indicative of whether the target substance is present in the analyte based on the signal from the resonant frequency detector. The electronic circuit is disposed on the first side of the sensor so as to be isolated from the analyte.

In yet another aspect, the invention is a method of making a membrane resonator, in which a membrane layer is deposited onto a top side of a rigid layer. The rigid layer also has a bottom side. A first conductive layer is deposited onto the membrane layer. A piezoelectric layer is deposited onto the first conductive layer. A second conductive layer is deposited onto the piezoelectric layer. A mask is applied onto the bottom side of the rigid layer. The mask defines a central hole passing therethrough. The bottom side of the rigid layer is etched through the hole so as to define a cavity through the rigid layer so that the membrane layer is exposed through the cavity. A functional material is applied to the membrane layer through the cavity. An actuating and sensing circuit is coupled to the first conductive layer and the second conductive layer.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a cross-sectional schematic diagram of the membrane resonator fabricated on a Silicon-on-Insulator wafer.

FIG. 2 is a cross-sectional schematic diagram of an alternative resonator design fabricated on a bulk Silicon wafer.

FIGS. 3A-3E are a series of schematic diagrams showing a mask process used to fabricate a resonator.

FIGS. 4A-4I are a series of schematic diagrams showing a deposition-based membrane resonator fabrication process.

FIG. 5 is a cross-sectional schematic diagram of a CMOS-integrated membrane sensor based on a deposition technique.

FIG. 6A is a cross-sectional schematic diagram of a fluid sensor array for sensing two different target substances.

FIG. 6B is a cross-sectional schematic diagram of a fluid sensor array with multiple sensing devices operating in parallel.

FIG. 7A is a cross-sectional schematic diagram of a membrane sensor employing an oscillating current actuator.

FIG. 7B is a cross-sectional schematic diagram of a membrane sensor employing optical oscillating frequency detection.

FIG. 7C is a cross-sectional schematic diagram of a membrane sensor employing magnetic oscillating frequency detection.

FIG. 7D is a cross-sectional schematic diagram of a membrane sensor employing electro-thermal oscillating frequency detection.

FIG. 8 is a cross-sectional schematic diagram of a particle sensor.

FIG. 9 is a scanning electron microscope micrograph of part of an array of piezoelectric resonators used as gravimetric sensors.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

The present invention includes a mid-frequency range high-Q piezoelectric gravimetric sensor platform that can be used for corrosive gas detection by introducing a high-order membrane resonator array that does not expose the electrode side to the gas. This resonator array platform can be used, for example, as an ammonia sensor with an organic functional material applied to the backside and shows a close agreement to the Freundlich adsorption isotherm up to 400 ppm. An uncoated non-functional reference resonator on an array of such sensors can be used to compensate for ambient noise and temperature sensitivity. The compensated gas response can achieve a low frequency bias instability of 0.012 Hz.

The present invention exposes the side opposite to the electrodes to the gas being sensed so that the electrodes are protected. This also results in the packaging process being simplified. In one embodiment, the present invention requires only three masks in fabrication. Thus, the fabrication cost can be significantly reduced. The present invention also integrates the sensor array integration so as to enhance sensitivity and can also be used for complex gas mixture analysis (such as for odor detection).

The present invention employs the gravimetric method, which tends to be power efficient since no active heat is required. The present invention can employ a mid-range frequency high order membrane mode resonator, which can be of a high-quality factor and a high sensitivity while consuming less power in operation.

The present invention includes a resonator array with multiple fully clamped membrane resonators having isolated front sides and back sides. The front side is patterned with electrodes for mechanical transduction and signal readout. It is unexposed during operation. On the other hand, the backside is exposed to the target gas or chemical through a cavity. The backside cavity also acts as a depositing reservoir for functional material, which allows the active functional material to be coated on the exposed resonator backside without requiring a micro-patterning tool. The membrane resonators can operate in a high order membrane mode to achieve high sensitivity, large quality factor, and to mechanically decouple multiple membrane resonators on the same chip. The high order membrane mode includes any higher-order mode of the base “trampoline” mode.

During operation, the membrane resonator is driven at a desired resonating mode frequency. A functional material that absorbs a target substance is deposited in the back side cavity. When the target substance is detected in an analyte gas, the operation frequency of the membrane drops due to the mass loading effect. The resonator transduction and frequency sensing methods cab include (but are not limited to): piezoelectric, electro-thermal, magnetic, and optical methods. The size of the membrane can be subject to different application requirements. Smaller sized membranes typically result in higher sensitivity while larger sized membranes typically result in a better quality factor.

Multiple membrane resonators in an array can be coated with the same functional material to enhance the sensitivity against one target substance in an analyte. Also, different membrane resonators coated selectively with different functional materials can be used to analyze a complex analyte mixture of several different target substances. A non-coated membrane resonator can be used as a reference to compensate for ambient noise. The side opposite from the cavity can be bonded to a conventional circuit technology (e.g., CMOS) cap by incorporating an electronic circuitry interface.

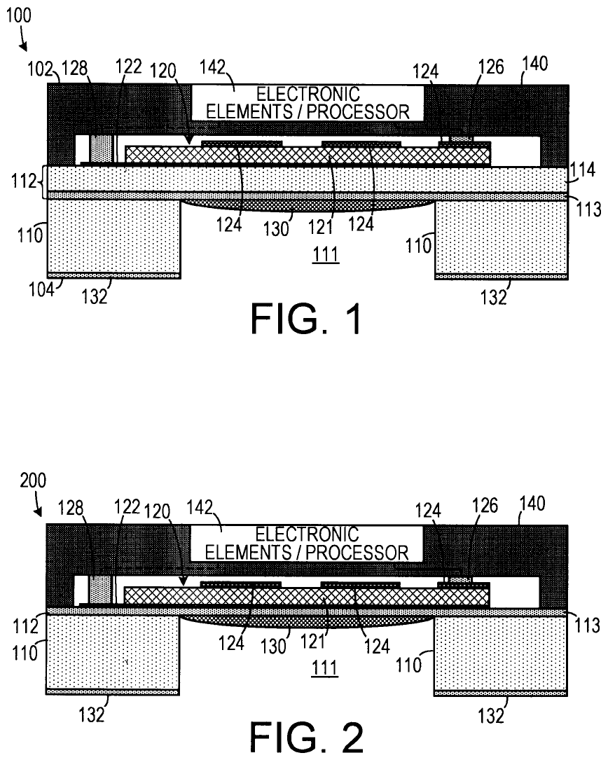

As shown in FIG. 1, one representative embodiment of a sensing device 100 has a first side 102 and an opposite second side 104. The sensor 100 includes a substrate 110 that defines a cavity 111 passing therethrough. A membrane 112 can include a rigid layer 114 (which can include a crystalline layer, such as silicone, silicon carbide, etc., or an amorphous layer, such as a glass) and a protective film 113, which can include a silicon oxide. A second protective film 132 (e.g., silicon oxide) can be applied to the bottom of the substrate 110. The bottom side of the membrane 112 is affixed to the substrate 110 so as to isolate the first side 102 of the sensing device 100 from the cavity 111. An actuator 120 is applied to the top side of the membrane 112. The actuator 120 includes a first conductive layer 122 upon which a piezoelectric layer 121 is applied. A second conductive layer 124 is applied to an opposite side of the piezoelectric layer 121. A first electrode 128 is electrically coupled to the first conductive layer 122 and a second electrode 126 is electrically coupled to the second conductive layer 124. Application of an oscillating potential between the first electrode 128 and the second electrode 126 results in the piezoelectric layer 121 and the membrane 112 vibrating at a resonant frequency of the combination of the piezoelectric layer 121 and the membrane 112. A processor and other electronic elements 142 control application of the potential between the first electrode 128 and the second electrode 126, and can also sense currents generated by the piezoelectric layer 121 in some embodiments. The second conductive layer 124 can be patterned so that potentials are applied locally to different parts of the piezoelectric layer 121. A capping layer 140 can be applied to the first side 102 of the sensing device 100.

In use, a functionalizing material 130 can be applied to the membrane 112 via the cavity 111. The functionalizing material 130 includes molecules that interact with a target substance in an analyte in such a way that when the target substance is present, the resonant frequency of the membrane 112 changes. When the new resonant frequency is detected, the sensing device 100 indicates that the target substance is present. In one embodiment, the membrane resonator 112 is coated with a molybdenum/aluminum nitride/molybdenum piezoelectric stack layer 120 with a transduction electrode 124 on the top side, which is fabricated on a Si-on-insulator wafer 110, which is bonded to a CMOS-type capping layer 140.

Such a device can be configured as an ammonia sensor, which can show a sub-ppm limit of detection and a dynamic range of over 400 ppm.

An alternate embodiment of a sensing device 200 is shown in FIG. 2. This embodiment can be used in situations in which the combination of the protective film 113 and the second electrode 126 are sufficient to act as the membrane 112. This embodiment can have a higher sensitivity than the embodiment shown in FIG. 1.

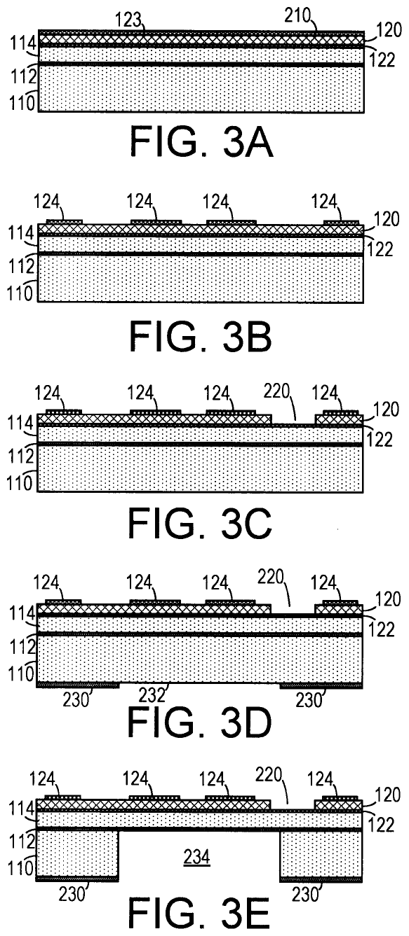

One simplified representative example of fabricating a membrane resonator is shown in FIGS. 3A-3E, in which a series of layers are deposited onto a silicon wafer substrate 110, as shown in FIG. 3A. The top metal layer 123 is patterned (e.g., through a conventional lithographic etching process) to form the top electrode 124, as shown in FIG. 3B. By patterning the top electrode 124, one can select a higher mode of vibration of the membrane 112. An access hole 220 is etched through the piezoelectric stack layer 120 to allow for access to the first conductive layer 122, as shown in FIG. 3C. A mask 230 (such as a plasma-enhanced chemical vapor deposited oxide) is applied to the bottom side of the substrate 110 layer. This can be an oxide layer (e.g., a silicon oxide layer) formed on the bottom side of the silicon substrate 110 layer, which is then patterned (e.g., through etching) to include an opening 232 therethrough, as shown in FIG. 3D. The substrate layer 110 is then etched to the protective membrane layer 112 to form the cavity 234, as shown in FIG. 3E. In this embodiment, the substrate wafer 110 can include, for example, silicon, polysilicon or combinations thereof. The electrodes 122 and 124 can include molybdenum or other appropriate metals, and the piezoelectric stack layer 120 can include an aluminum nitride (AlN) film.

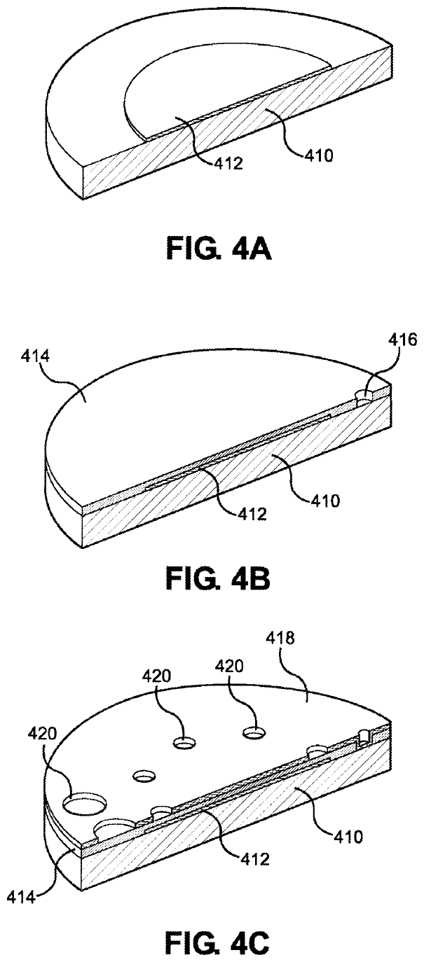

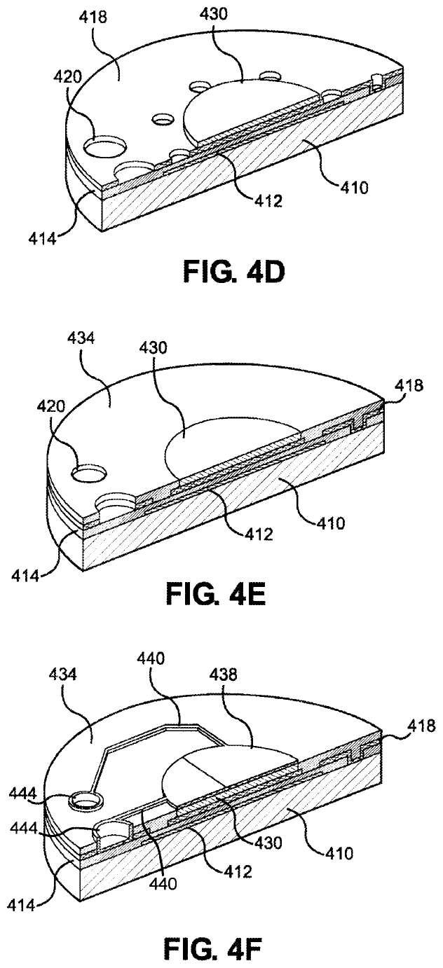

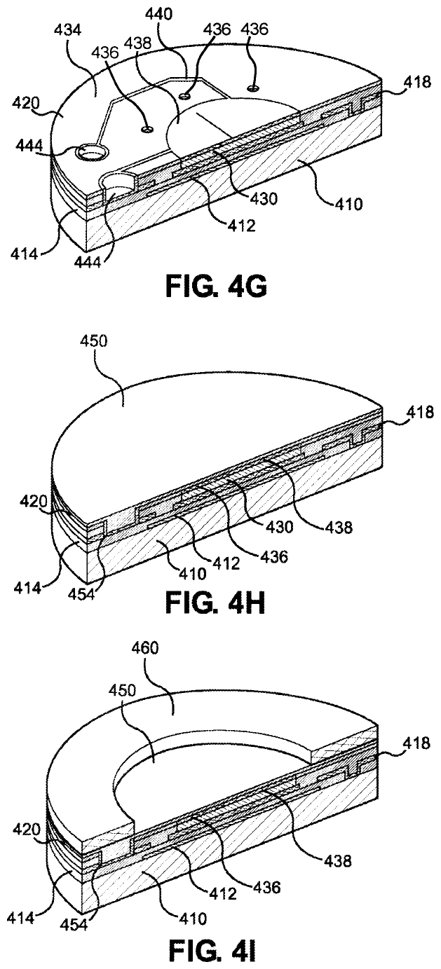

Fabrication of a more complex device is shown in FIGS. 4A-4I. As shown in FIG. 4A, amorphous silicon 412 is applied to a CMOS-compatible material. A silicon dioxide layer 414 is applied thereto and an access hole 416 can be formed therein, as shown in FIG. 4B. A metal electrode layer 418 is applied thereto (which can be done using a known method such as chemical vapor deposition, sputtering, etc.) and a plurality of access holes 420 can be formed therethrough, as shown in FIG. 4C. A piezoelectric layer 430 is applied thereto, as shown in FIG. 4D. A silicon layer 434 is then applied to the metal electrode layer 418 while not covering the piezoelectric layer 430, as shown in FIG. 4E. As shown in FIG. 4F, a second metal layer is deposited onto the piezoelectric layer 430 and the silicon layer 434 and is patterned into an electrode 438 that can include connections 440 to one or more vias 444. Access holes 436 are etched into the silicon layer 434, as shown in FIG. 4G, and another silicon membrane layer 450 is deposited thereon, as shown in FIG. 4H. A silicon (or polysilicon, etc.) layer 460 is applied thereto and etched to form the cavity 450 as shown in FIG. 4I.

The backside cavity is used as a functional material depositing reservoir, allowing the active functional material to be coated on the exposed resonator backside without requiring a micro-patterning tool. The membrane resonators are designed to operate in high order membrane mode to achieve high sensitivity, large quality factor, and to mechanically decouple multiple membrane resonators on the same chip. The term “high order membrane mode” means any mode of higher-order than a base trampoline mode.

During operation, the membrane resonator is driven at the designed resonating mode frequency. Upon the backside functional material absorbing the analyte gas/chemical, the operation frequency drops due to the mass loading effect. The resonator transduction and frequency sensing methods include but are not limited to piezoelectric, electro-thermal, magnetic, and optical methods. The size of the membrane is subject to different application requirements. Smaller size usually gives higher sensitivity while larger size gives better quality factor, so the design can be a trade-off between the two specifications.

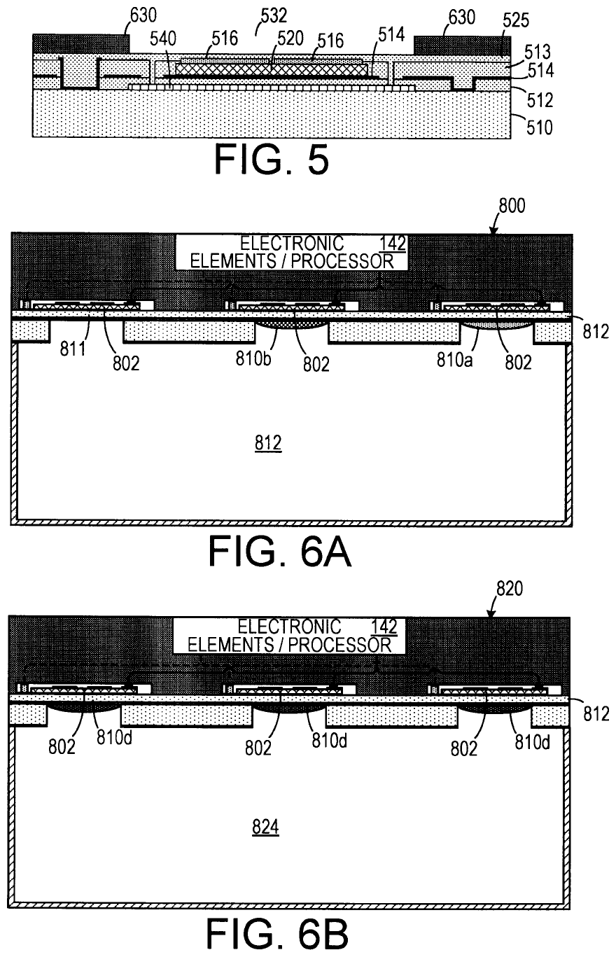

As shown in FIG. 5, in an alternative process flow, one or more membrane sensors can be integrated on top of a CMOS wafer 510 via a deposition-based technique without the need for wafer-to-wafer bonding. The process starts with a CMOS wafer 510 that already contains the interfacing circuit used to actuate, readout, and compensate the sensor. A sacrificial amorphous silicon layer is deposited onto the CMOS wafer 510 and is patterned so as to define the membrane 540 geometry. The surface is then covered with thick oxide 512, with a through hole etched for the ground electrode to access the CMOS wafer 510. The ground/bottom electrode 514 is then sputter deposited with patterns to reserve space for the releasing hole and top electrode 516 access. Next, the piezoelectric layer 520 is deposited and patterned according to the resonator design, followed by depositing another layer of oxide 513 for preventing the top electrode from being deposited at the side wall of the piezoelectric layer. This oxide 513 also isolates the top and bottom electrodes. The oxide 513 is again etched to create vias for the top electrode to access the bottom COMS wafer 510. The top electrode 516 is sputtered and patterned based on the resonator mode shape. Then, release holes are etched through the oxide layer 513, and the sacrificial amorphous Si is released using an etch such as XeF₂. A final layer of TEOS oxide 525 is conformably deposited on top to cover the top electrode and close up the releasing holes. Next, to facilitate the functional material coating process, a reservoir 532 is added by patterning a thick wall 630 around the membrane 540, which can be done, for example, through electroplating. It should be noted that while this process is a low-cost process for integration of membrane sensors with CMOS, it can also be carried out on one of many other substrate types, such as glass, silicon, silicon carbide, etc.

Also, the structural and sacrificial layers are not limited to silicon dioxide or amorphous silicon. Any material can be used as sacrificial or structural layers. The piezoelectric layer can include, for example, AIN, AIScN, PZT, ZnO, or one of many other films that can coat a wafer.

As shown in FIG. 6A, one embodiment includes a resonator array 800 that can include a plurality of fully clamped membrane resonators 802, each of which has a cavity that is isolated from the top side of the array. The top side of the array is patterned with electrodes for mechanical transduction and for signal readout. The electronics side is not exposed to the analyte 812 during operation. In the embodiment shown in FIG. 6A, a first sensor unit can have a first functional material 810a applied to a shared membrane layer 812. A second sensor unit can have a second functional material 810b applied to the shared membrane layer 812 and a third sensor unit 811 can have a no functional material applied to the local area of the shared membrane layer 812. The first functional material 810a can be reactive with a first target substance and the second functional material 810b can be reactive with a second target substance that is different from the first target substance. The third sensor unit 811 can act as a reference sensor for compensating for ambient noise. While only three sensors are shown, it should be noted that many more sensors can be employed with each one including a different functional material for detecting many different substances in the analyte 812. An electronics suite and processor 142 can be coupled to the membrane resonators 802 for applying an actuating signal to each piezoelectric stack and for processing information collected from the membrane resonators 802 once exposed to the analyte. This embodiment, by using selectively coated resonators with different functional materials, can be used to analyze a complex analyte mixture.

As shown in FIG. 6B, the multiple membrane resonators 802 on the array can be also be coated with the same functional material to enhance the sensitivity of the device with respect to one target analyte.

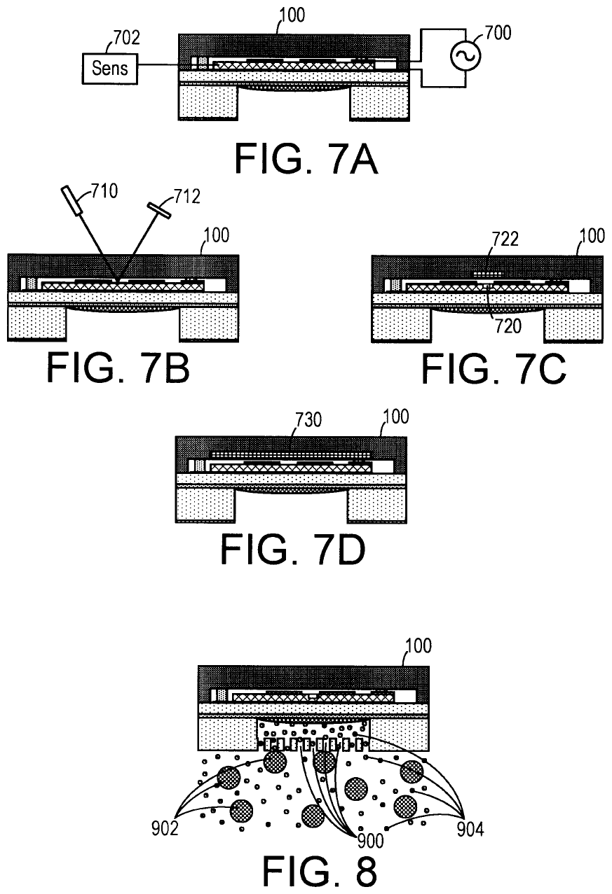

As shown in FIG. 7A, an oscillating voltage source 700 (which can be integrated with the device) can be used to apply an activating voltage of a first frequency to the piezoelectric stack. A current or voltage sensor 702 can be used to monitor the change in oscillating frequency resulting from exposure to the analyte. A sensor employing an optical membrane frequency sensor is shown in FIG. 7B, in which a laser 710 directs a coherent light beam at the membrane and a light sensor 712 senses reflected light therefrom. One type of optical displacement sensor that could be employed with this embodiment is disclosed in U.S. Pat. No. 7,852,898, which is incorporated herein by reference. A magnetic sensor embodiment is shown in FIG. 7C, in which a magnetic domain 720 is integrated into the membrane or piezoelectric stack and a magnetic sensor 722 is placed in a fixed point of reference relative to the membrane. A heat-sensor 730 can be used to detect changes in heat flux in a heat detecting embodiment, as shown in FIG. 7D. A particle sensor is shown in FIG. 8, in which a filter blocks access to the cavity. The filter has a plurality of pores 900 that have an inside diameter that allows particles 904 having an outside diameter that is smaller than the pore diameter to pass through, but that blocks particles 902 with a larger outside diameter. This embodiment could be employed in, for example, air quality assays, etc. It should be understood that the present invention can be adapted for many other applications by manipulating the choice of functionalizing materials, the sensor dimensions and the like.

One embodiment of the present invention can be used as a low-power gas, biochemical, and/or particulate matter sensor. Some example applications include ammonia monitoring for diagnosing kidney disease, CO₂ sensing for greenhouse gas monitoring, PM2.5 level monitoring, and sweat monitoring for wearable devices.

One experimental embodiment includes a circular membrane resonator that can operate at a relatively lower MHz range. It showed low motional impedance and high Q in the air while maintaining a satisfactory gravimetric sensitivity. The membrane resonator diameter was selected at 1 mm to match the tip size of a precision syringe used for the coating it with the functional material. A polysilicon-on-Insulator wafer with the device layer thickness of 12 μm was chosen for this design. A thinner substrate and a smaller diameter could improve the sensitivity.

A higher-order mode was preferred to enhance the sensitivity. Also, a large order number also requires more electrodes for efficient piezoelectric transduction, which is challenging to put on a micro gravimetric resonator. The experimental embodiment included a (4,2) mode membrane resonator with 16 electrode pads. The chosen mode also benefits from a high Q anchor, which is important for reducing the coupling of resonators through the substrate in an array. The gravimetric sensitivity of the (4,2) membrane resonator operating at 2.9 MHz was characterized as S=47 Hz·μm²/fg, with a simulated Q_{anchor}=77,000. Both numbers outperform a conventional trampoline mode oscillator operation at 223 kHz (S=3 Hzμm²/fg and Q_{anchor}=1400). The piezoelectric electrodes were placed at the high-stress region to excite the desired (4,2) mode with low motional impedance.

One experimental embodiment of the piezoelectric membrane resonator array was fabricated with a 3-mask process. Starting with a polysilicon-Insulator wafer, a piezoelectric stack that included 1.3 μm aluminum nitride (AlN) sandwiched by two 100 nm molybdenum (Mo) layers was deposited on the front side device layer. The first mask patterned the top electrode, trace, and pads. Then the second mask was etched through AIN to expose the bottom Mo electrode for ground connections. Next, an oxide hard mask was deposited and patterned for etching through the backside handle layer that defines the membrane diameter. Finally, the excessive buried oxide was removed by a short hydrofluoric acid etching.

Each resonator array included 20 individual membrane resonators on a 1×1 cm die. With the 1 mm diameter handle layer etching serving as a coating reservoir, device functionalization was easily achieved by loading this reservoir. Since the polysilicon device layer was intact during fabrication, the front side piezoelectric layer remained isolated when the resonator is coated and exposed to gas from the other side.

In one embodiment, carboxylic functionalized polymers and nanoparticles were used for ammonia sensing. The carboxylic group reacts with ammonia. It transfers a hydrogen ion to the lone pair on the nitrogen and forms an ammonium ion. Another commonly used material for ammonia sensing is doped polyaniline (PANI-H⁺), though typically used in chemi-resistive methods.

This experimental embodiment used both reactions to improve gas absorption. Carboxylic functionalized PANI was prepared using the following steps, with all chemicals purchased from Sigma Aldrich: 1 g of PANI was dissolved in 180 ml of formic acid, which provided the carboxylic function group, with 20 ml of diethyl phthalate added as a plasticizer to form stock solution A. Then, 12% weight ratio of polyvinylpyrrolidone (PVP) as a suspending agent was dissolved into methanol in a separate beaker as stock solution B. Finally, stock solutions A and B were mixed with a volume ratio of 4:1. The final solution was then loaded and deposited into the backside coating reservoir using a precision syringe, followed by 30 mins baking at 95° C. to remove excess liquid, leaving a functionalized film on the back of the membrane resonator.

A scanning electron microscope micrograph of part of an experimental embodiment of an array of piezoelectric resonators used as gravimetric sensors according to the invention is shown in FIG. 9.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A sensor, having a first side and an opposite second side, for sensing at least one target substance in an analyte that is disposed adjacent to the second side, comprising:
(a) a first sensing device, including:
(i) a substrate that defines a cavity therethrough, the cavity configured to receive the analyte therein;
(ii) a membrane, having a top side and an opposite bottom side, the bottom side affixed to the substrate so as to isolate the top side of the membrane and the first side of the sensor from the first cavity;
(iii) an actuator affixed to the top side of the membrane and configured to cause the membrane to vibrate at a first frequency;
(iv) a functionalizing material applied to the bottom side of the membrane and exposed to the cavity, the functionalizing material having a property such that when the target substance comes in contact with the functionalizing material, the membrane resonates at a second frequency that is different from the first frequency; and
(v) a resonant frequency detector that generates a signal that indicates whether the membrane is resonating at the first frequency or at the second frequency; and
(b) an electronic circuit that is responsive to the signal from the resonant frequency detector and that is configured to generate an output indicative of whether the target substance is present in the analyte based on the signal from the resonant frequency detector, the electronic circuit being disposed on the first side of the sensor so as to be isolated from the analyte.

2. The sensor of claim 1, wherein the substrate comprises a crystalline substance.

3. The sensor of claim 1, wherein the crystalline substance comprises silicon.

4. The sensor of claim 1, wherein the substrate comprises a rigid amorphous substance.

5. The sensor of claim 1, wherein the actuator comprises:
(a) a piezoelectric layer having a first side and an opposite second side;
(b) a first electrode disposed on the first side of the piezoelectric layer; and
(c) a second electrode disposed on the second side of the piezoelectric layer,
wherein when an oscillating potential difference is applied between the first electrode and the second electrode, the piezoelectric layer vibrates.

6. The sensor of claim 5, wherein resonant frequency detector is selected from a list of detectors consisting of: a voltage sensor that is electrically coupled to the piezoelectric layer and configured to an oscillating voltage generated by the piezoelectric member;
an optical detector; a magnetic detector; and an electro-thermal sensor.

7. The sensor of claim 1, wherein the membrane comprises a silicon layer.

8. The sensor of claim 1, wherein the membrane comprises a silicon oxide film.

9. The sensor of claim 1, further comprising a capping material applied to the first side of the sensor.

10. The sensor of claim 1, configured as a particulate matter sensor and comprising a filter disposed on the second side, the filter defining a plurality of openings therethrough wherein each opening has an inside diameter that allows particles with an outside diameter less than the inside diameter to pass into the cavity, but that does not allow particles with an outside diameter greater than the inside diameter to pass into the cavity.

11. The sensor of claim 1, configured as a sweat sensor, wherein the functional material is chosen so as to be able to detect a selected one of viscosity or composition of perspiration.

12. A fluid sensor, having a first side and an opposite second side, for sensing at least one target substance in an analyte that is disposed adjacent to the second side, comprising:
(a) a substrate;
(b) a plurality of sensing devices formed on the substrate, each sensing device including:
(i) a cavity defined through the substrate, the cavity configured to receive the analyte therein;
(ii) a membrane, having a top side and a bottom side, the bottom side affixed to the substrate so as to isolate the top side of the membrane and the first side of the sensor from the first cavity;
(iii) an actuator affixed to the top side of the membrane and configured to cause the membrane to vibrate at a first frequency;
(iv) a functionalizing material applied to the bottom side of the membrane and exposed to the cavity, the functionalizing material having a property such that when the target substance comes in contact with the functionalizing material, the membrane resonates at a second frequency that is different from the first frequency; and
(v) a resonant frequency detector that generates a signal that indicates whether the membrane is resonating at the first frequency or at the second frequency; and
(c) an electronic circuit that is responsive to the signal from the resonant frequency detector and that is configured to generate an output indicative of whether the target substance is present in the analyte based on the signal from the resonant frequency detector, the electronic circuit being disposed on the first side of the sensor so as to be isolated from the analyte.

13. The sensor of claim 12, further comprising a reference sensing device that includes:
(a) a cavity through the substrate, the cavity configured to receive the analyte therein;
(b) a membrane, having a top side and a bottom side, the bottom side affixed to the substrate so as to isolate the top side of the membrane and the first side of the sensor from the first cavity;
(c) an actuator affixed to the top side of the membrane and configured to cause the membrane to vibrate at a first frequency; and
(d) a resonant frequency detector that generates a signal that indicates whether the membrane is resonating at the first frequency or at the second frequency,
wherein the membrane of the reference cavity does not have any functionalizing material applied thereto.

14. The sensor of claim 12, wherein each membrane in the plurality of sensing devices includes a different functionalizing material, wherein each different functionalizing material reacts with a different target substance.

15. The sensor of claim 12, wherein the substrate comprises a crystalline substance.

16. The sensor of claim 12, wherein the crystalline substance comprises silicon.

17. The sensor of claim 12, wherein the actuator comprises:
(a) a piezoelectric layer having a first side and an opposite second side;
(b) a first electrode disposed on the first side of the piezoelectric layer; and
(c) a second electrode disposed on the second side of the piezoelectric layer,
wherein when an oscillating potential difference is applied between the first electrode and the second electrode, the piezoelectric layer vibrates.

18. The sensor of claim 17, wherein resonant frequency detector is selected from a list of detectors consisting of: a voltage sensor that is electrically coupled to the piezoelectric layer and configured to an oscillating voltage generated by the piezoelectric member; an optical detector; a magnetic detector; and an electro-thermal sensor.

19. The sensor of claim 12, further comprising a capping material applied to the first side of the sensor.

20. A method of making a membrane resonator, comprising the steps of:
(a) depositing a membrane layer onto a top side of a rigid layer, the rigid layer also having a bottom side;
(b) depositing a first conductive layer onto the membrane layer;
(c) depositing a piezoelectric layer onto the first conductive layer;
(d) depositing a second conductive layer onto the piezoelectric layer;
(e) applying a mask onto the bottom side of the rigid layer, the mask defining a central hole passing therethrough;
etching the bottom side of the rigid layer through the hole so as to define a cavity through the rigid layer so that the membrane layer is exposed through the cavity;
(g) applying a functional material to the membrane layer through the cavity; and
(h) coupling an actuating and sensing circuit to the first conductive layer and the second conductive layer.

21. The method of claim 20, further comprising the step of patterning the second conductive layer to form at least one electrode.

22. The method of claim 20, wherein the rigid layer comprises a crystalline substance.
